(19) United States
(12) Patent Application Publication
(10) Pub. No.: US 2026/0370430 A1
(43) Pub. Date: Nov. 19, 2026

(54) UE-Initiated Beam Measurement Reporting to Trigger Layer-1 Based Mobility in Wireless Communication

(71) Applicant: Apple Inc., Cupertino, CA (US)

(72) Inventors: Hong HE, San Jose, CA (US); Chunxuan YE, San Diego, CA (US); Dawei ZHANG, Saratoga, CA (US); Haitong SUN, Saratoga, CA (US); Qiming LI, Beijing (CN); Wei ZENG, Saratoga, CA (US)

(21) Appl. No.: 19/155,659

(22) PCT Filed: Feb. 14, 2023
(86) PCT No.: PCT/CN2023/075924

§ 371 Date: Aug. 12, 2025

(51) Int. Cl. H04L 5/00; H04W 24/10; H04W 72/21

(52) U.S. Cl. CPC H04L 5/0094; H04W 24/10; H04W 72/21

(57) ABSTRACT

channel state information (CSI) report configuration that includes parameters to detect a triggering event for a UE-initiated CSI report, the triggering event being based on measurement results derived based on reference signals (RS) received from a serving cell and measurement results derived based on RS received from at least one non-serving cell, detect the triggering event based on at least the measurement results derived based on the RS received from the serving cell and the at least one non-serving cell and if the UE-initiated CSI report does not have a lower priority than a network-initiated CSI report that overlaps with the UE-initiated CSI report, transmit the UE-initiated CSI report that includes the measurement results derived based on the RS received from the serving cell and the at least one non-serving cell.

### TECHNICAL FIELD

The present disclosure generally relates to wireless communication, and in particular, to UE-initiated beam measurement reporting to trigger layer-1 based mobility in wireless communication.

### BACKGROUND INFORMATION

In 3GPP 5G New Radio (NR), channel state information (CSI) reporting can be configured for a user equipment (UE) by a network cell. The CSI report configuration includes a field for a CSI report type, e.g., periodic, semi-persistent or aperiodic, and fields for measurement resources, e.g., channel measurement resources (CMR) and (optional) interference measurement resources (IMR). CSI reporting can be used in beam management procedures, e.g., layer 1 (L1) inter-cell beam management procedures. Various issues exist with regard to CSI reporting for inter-cell beam management in L1/L2-Triggered Mobility (LTM) procedures.

### SUMMARY

Some exemplary embodiments are related to a processor of a user equipment (UE) configured to receive a channel state information (CSI) report configuration that includes parameters to detect a triggering event for a UE-initiated CSI report, the triggering event being based on measurement results derived based on reference signals (RS) received from a serving cell and measurement results derived based on RS received from at least one non-serving cell, detect the triggering event based on at least the measurement results derived based on the RS received from the serving cell and the at least one non-serving cell and if the UE-initiated CSI report does not have a lower priority than a network-initiated CSI report that overlaps with the UE-initiated CSI report, transmit the UE-initiated CSI report that includes the measurement results derived based on the RS received from the serving cell and the at least one non-serving cell.

Other exemplary embodiments are related to a processor of a base station configured to transmit to a user equipment (UE) a channel state information (CSI) report configuration that includes parameters to detect a triggering event for a UE-initiated CSI report, the triggering event being based on measurement results derived based on reference signals (RS) received from a serving cell and measurement results derived based on RS received from at least one non-serving cell and if the UE-initiated CSI report does not have a lower priority than a network-initiated CSI report that overlaps with the UE-initiated CSI report, receive the UE-initiated CSI report after the UE detects the triggering event based on at least the measurement results derived based on the RS received from the serving cell and the at least one non-serving cell.

Still further exemplary embodiments are related to a processor of a user equipment (UE) configured to receive a channel state information (CSI) report configuration that includes parameters to construct a CSI report, wherein the parameters include one or more RS for a serving cell and one or more RS for a non-serving cell, the parameters further include a value that indicates a number of RS to report or a maximum number of RS to report per report setting, construct a medium access control (MAC) control element (MAC-CE) that includes a field that indicates a presence of measurement results for the serving cell or one of the non-serving cells, the MAC-CE further includes indices and the measurement results for the one or more RS for the serving cell or the one or more RS for the one of the non-serving cells, wherein the measurement results are provided in order of decreasing measurement quantities and transmit the MAC-CE that includes the measurement results for the number of RS or a number of RS less than the maximum number of RS with associated measurement values as the CSI report.

### BRIEF DESCRIPTION OF THE DRAWINGS

FIG. 1 shows a network arrangement according to various exemplary embodiments.

FIG. 2 shows an exemplary UE according to various exemplary embodiments.

FIG. 3 shows an exemplary network cell according to various exemplary embodiments.

FIG. 4a shows a portion of a CSI-ReportConfig IE for configuring a CSI report according to existing specification.

FIG. 4b shows a CSI-ResourceConfig IE for defining a group of one or more resource sets for CSI measurements according to existing specification.

FIG. 4c shows a CSI-SSB-ResourceSet IE for configuring a resource set for CSI measurements according to existing specification.

FIG. 5a shows a portion of a CSI-ReportConfig IE for configuring a CSI report including one or more parameters for detecting a UE-initiated CSI reporting trigger event according to various exemplary embodiments.

FIG. 5b shows a CSI-SSB-ResourceSet IE for configuring a resource set for CSI measurements including, on a per resource set basis, one or more parameters for detecting a UE-initiated CSI reporting trigger event according to various exemplary embodiments.

FIG. 5c shows a CSI-SSB-ResourceSet IE for configuring a resource set for CSI measurements including, on a per non-serving cell basis, one or more parameters for detecting a UE-initiated CSI reporting trigger event according to various exemplary embodiments.

FIG. 6 shows an exemplary signaling diagram for a UE-initiated CSI report using a UL grant provided in response to a scheduling request (SR) according to various exemplary embodiments.

FIG. 7 shows a method for UE-initiated CSI reporting based on the detection of a trigger event according to various exemplary embodiments.

FIG. 8 shows an exemplary plot of measurement results for a first cell and a second cell with respect to an exemplary threshold value according to various exemplary embodiments.

FIG. 9a shows a fixed size MAC-CE for LI CSI reporting for LTM procedures according to various exemplary embodiments.

FIG. 9b shows a variable size MAC-CE for L1 CSI reporting for LTM procedures according to various exemplary embodiments.

FIG. 10 shows a method for constructing a CSI report for non-serving cell beam reporting for L1/L2 Triggered Mobility (LTM) according to various exemplary embodiments.

### DETAILED DESCRIPTION

The exemplary embodiments may be further understood with reference to the following description and the related appended drawings, wherein like elements are provided with the same reference numerals. The exemplary embodiments describe inter-cell beam management operations including enhancements to layer 1 (L1) measurement and channel state information (CSI) reporting.

New mobile services that require low-latency and high reliability performance (e.g., ultra-reliable low latency communications (URLLC) ) are emerging. While the 5G New Radio (NR) standards have been designed to address these services from the outset, the evolution of 5G NR should continuously enhance the mobility robustness performance for these challenging scenarios. There is a need for layer 1 (L1) enhancements for inter-cell beam management, including L1 measurement/reporting and beam indication. Various issues have been identified for L1 measurements for L1/L2-Triggered Mobility (LTM) procedures.

In a first issue, for mobility use cases, it is critical and necessary to configure a huge amount of target candidate cells and beams to perform L1 measurements and then timely trigger handover (HO) operations to reduce latency. Periodic CSI reporting or network-triggered CSI reporting can create huge overhead and unnecessarily increase the report latency.

In a second issue, it remains open regarding how to report the L1 measured results associated with different neighbor cells to serve the mobility use case in an efficient manner.

In a third issue, a detailed design of the CSI report, e.g., fixed size or variable size, for a Physical Uplink Shared Channel (PUSCH) as a container for the CSI report remains open.

According to various exemplary embodiments described herein, operations are described for addressing the issues identified above with regard to CSI reporting for inter-cell beam management in L1/L2-Triggered Mobility (LTM) procedures.

In some aspects, a user equipment (UE) initiates the CSI reporting for LTM based on the detection of a triggering event. The event detection can be based on beam measurement results, e.g., reference signal received power (RSRP) or signal-to-noise ratio (SINR), for a serving cell and one or more non-serving cells. In some embodiments, the UE-initiated CSI reporting can be triggered when the UE detects the measurement results of a non-serving cell are some offset value better than (e.g., greater than) the measurement results of the serving cell. In other embodiments, the UE-initiated CSI reporting can be triggered when the UE detects the measurement results of the serving cell are worse than (e.g., less than) some first threshold value and/or the measurement results of a non-serving cell are better than (e.g., greater than) some second threshold value. The network can configure the UE, via radio resource control (RRC) signaling, with one or more of the offset value, the first threshold value and/or the second threshold value and can further configure the UE with a type of measurement result to be measured against these values (e.g., RSRP or SINR). In one embodiment, these parameters can be configured per CSI report and used for each beam associated with the CSI report. In other embodiments, these parameters can be configured per resource set.

In further aspects, resources can be allocated for the UE-initiated CSI reporting associated with LTM events according to various options. In some embodiments, the CSI report is transmitted on semi-persistent (SP) physical uplink control channel (PUCCH) resources. In other embodiments, the CSI report is transmitted on physical uplink shared channel (PUSCH) resources. In some embodiments, the PUSCH resources can be requested via scheduling request (SR) or random access channel (RACH) procedures. In the case of collision between the UE-initiated CSI report and a network-initiated CSI report, either one of the two types of CSI report can be prioritized based on a hard-encoded rule, network indication (e.g., system information block (SIB) or dedicated RRC), or UE implementation.

In still further aspects, the CSI report can be constructed in various ways. In some embodiments, when the CSI report is transmitted on the PUSCH, the CSI report can be transmitted via an uplink (UL) medium access control (MAC) control element (MAC-CE). The MAC-CE can have a fixed size or a variable size. The network can configure the UE with a number of beams to report on a per-CSI report or per-cell basis. Additionally, in some embodiments, the network can configure the UE with a threshold measurement value so that the beam measurements can be filtered prior to reporting so that only those beams whose measured results are above the threshold measurement value are included in the CSI report.

The exemplary aspects are described with regard to a UE. However, the use of a UE is provided for illustrative purposes. The exemplary aspects may be utilized with any electronic component that may establish a connection with a network and is configured with the hardware, software, and/or firmware to exchange information and data with the network. Therefore, the UE as described herein is used to represent any electronic component that is capable of accessing a wireless network and performing CSI operations.

The exemplary aspects are described with regard to the network being a 5G New Radio (NR) network and a base station being a next generation Node B (gNB). However, the use of the 5G NR network and the gNB are provided for illustrative purposes. The exemplary aspects may apply to any type of network and network components that utilize similar functionalities.

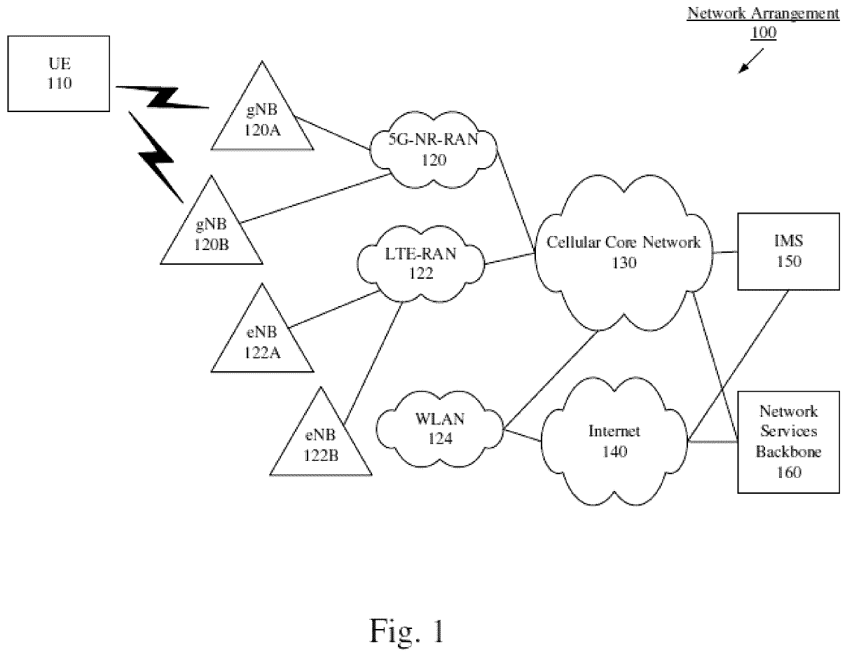

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., a component of a connected car, a mobile phone, a tablet computer, a smartphone, a phablet, an embedded device, a wearable, an Internet of Things (IoT) device, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary embodiments, the UE 110 may establish a connection with the 5G NR-RAN 122.

The 5G NR-RAN 120 and the LTE-RAN 122 may be portions of cellular networks that may be deployed by cellular providers (e.g., Verizon, AT&T, Sprint, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via at least one of the next generation nodeB (gNB) 120A and/or the gNB 120B. The gNBs 120A, 120B may be configured with the necessary hardware (e.g., antenna array), software and/or firmware to perform massive multiple in multiple out (MIMO) functionality. Massive MIMO may refer to a base station that is configured to generate a plurality of beams for a plurality of UEs. Reference to two gNB 120A, 120B is merely for illustrative purposes. The exemplary embodiments may apply to any appropriate number of gNBs. Specifically, the UE 110 may simultaneously connect to and exchange data with a plurality of gNBs 120A, 120B in a multi-cell CA configuration or a multi-TRP configuration. The UE 110 may also connect to the LTE-RAN 122 via either or both of the eNBs 122A, 122B, or to any other type of RAN, as mentioned above. In the network arrangement 100, the UE 110 is shown as having a simultaneous connection to the gNBs 120A and 120B. The connections to the gNBs 120A, 120B may be, for example, multi-TRP connections where both of the gNBs 120A, 120B provide services for the UE 110 on a same channel.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

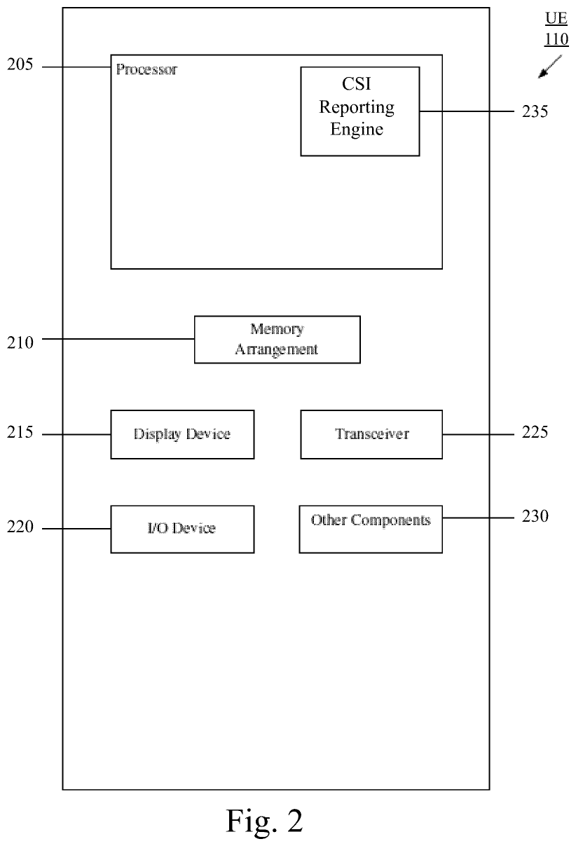

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a channel state information (CSI) reporting engine 235. The CSI reporting engine 235 may perform operations including receiving a CSI report configuration, performing CSI measurements and generating a CSI report. To be described in further detail below, the CSI reporting engine 235 may perform operations including receiving configuration parameters for UE-initiated CSI reporting, detect the occurrence of a triggering event, and transmit the CSI report when the triggering event is detected. Additionally, to be described in further detail below, the CSI reporting engine 235 may perform operations including receiving configuration parameters for constructing the CSI report and transmit the CSI report in dependence on these parameters. The specific implementations for various scenarios will be described in further detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE. The memory 210 may be a hardware component configured to store data related to operations performed by the UE 110.

The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies).

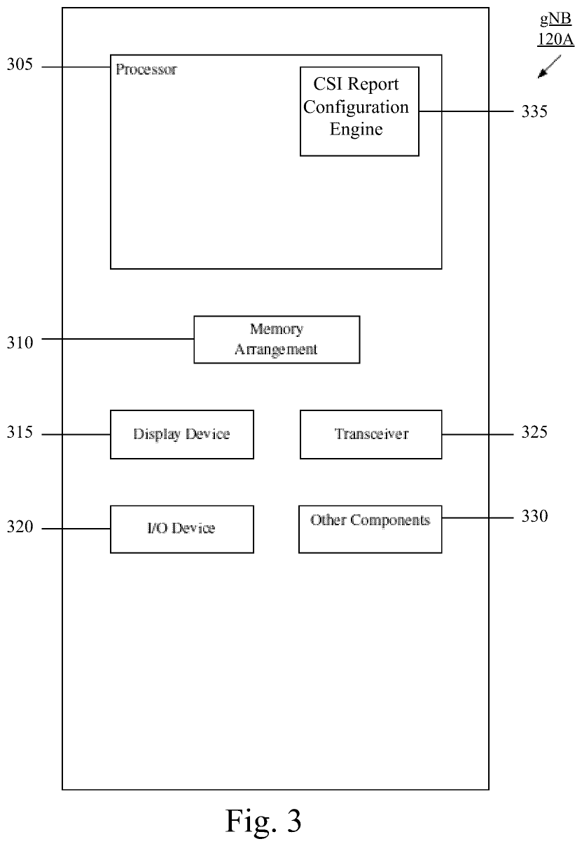

FIG. 3 shows an exemplary network cell, in this case gNB 120A, according to various exemplary embodiments. As noted above with regard to the UE 110, the gNB 120A may represent a cell in a multi-TRP configuration with the UE 110. The gNB 120A may represent any access node of the 5G NR network through which the UEs 110, 112 may establish a connection and manage network operations. The gNB 120A illustrated in FIG. 3 may also represent the gNB 120B.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a CSI report configuration engine 335. The CSI report configuration engine 335 may perform operations including configuring the UE with one or more CSI reports, receiving one or more CSI reports, and performing mobility procedures in dependence on the measurement results included in the report(s). To be described in further detail below, the CSI reporting engine 235 may perform operations including configuring the UE with parameters for UE-initiated CSI reporting for the UE to detect the occurrence of a triggering event and receive the CSI report when the triggering event is detected by the UE and the report is transmitted. Additionally, to be described in further detail below, the CSI reporting engine 235 may perform operations including configuring the UE with parameters for constructing the CSI report and receiving the CSI report constructed in dependence on these parameters. The specific implementations for various scenarios will be described in further detail below.

The above noted engines each being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary embodiments may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UEs 110, 112 and any other UE in the system 100, e.g., if the gNB 120A serves as a PCell or an SCell to either or both of the UEs 110, 112. The transceiver 325 may operate on a variety of different frequencies or channels (e.g., set of consecutive frequencies). Therefore, the transceiver 325 may include one or more components (e.g., radios) to enable the data exchange with the various networks and UEs.

In the 3GPP 5G NR specifications, channel state information (CSI) is reported by a UE to a gNB and may include some or all of the following information: a CSI-RS resource index (CRI), a Rank Indicator (RI), a Precoder Matrix Indicator (PMI), a Layer Indicator (LI), and/or a Channel Quality Indicator (CQI). The CSI may be reported by a Physical Uplink Shared Channel (PUSCH), a short Physical Uplink Control Channel (PUCCH) or a long PUCCH.

The CSI reporting can be configured for a user equipment (UE) by a network cell. The CSI report configuration may include a field for a CSI report type, e.g., periodic, semi-persistent or aperiodic, and fields for measurement resources, e.g., channel measurement resources (CMR) and (optional) interference measurement resources (IMR). The measurement resources may be used by the UE for performing channel measurements on RS such as NZP-CSI-RS, SSB or CSI-IM.

In 3GPP TS 38.331, the CSI-ReportConfig information element (IE) is used to configure: a periodic or semi-persistent CSI report sent on PUCCH on the cell in which the CSI-ReportConfig is included; or a semi-persistent or aperiodic CSI report sent on PUSCH triggered by DCI received on the cell in which the CSI-ReportConfig is included (in this case, the cell on which the report is sent is determined by the received DCI).

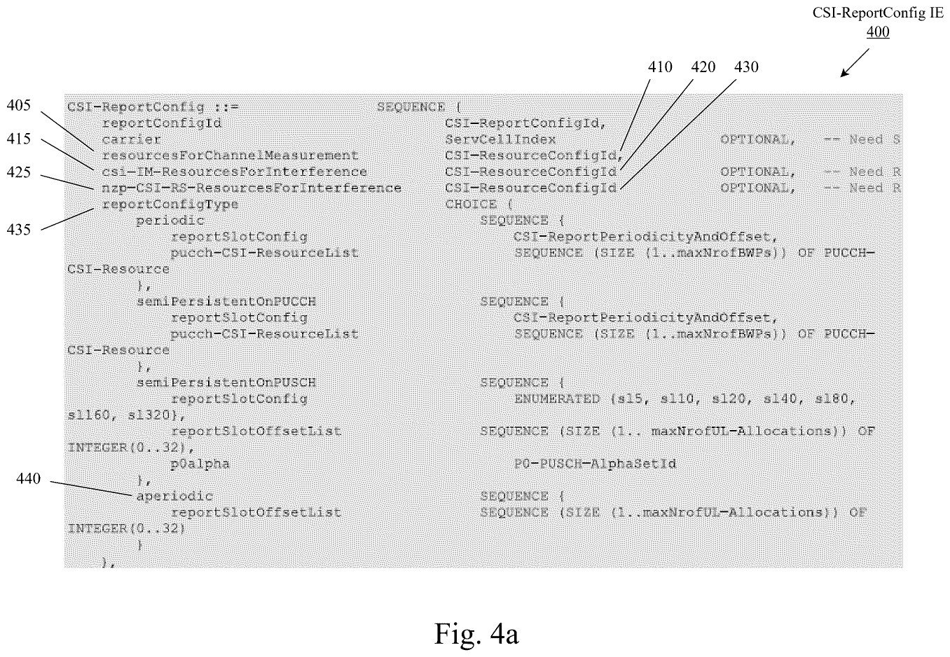

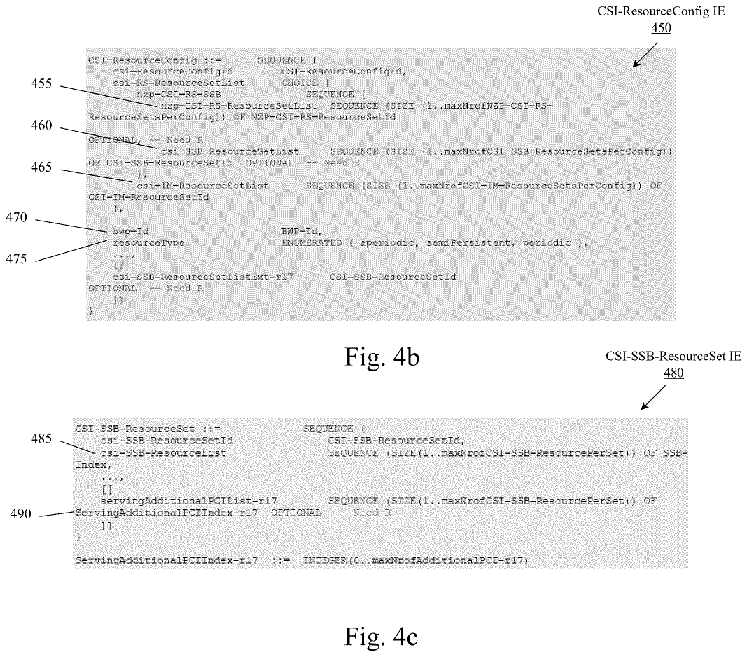

FIG. 4a shows a portion of a CSI-ReportConfig IE 400 for configuring a CSI report according to existing specification. The CSI-ReportConfig IE 400 can configure three possible types of measurement resources: a channel measurement resource (CMR) (field 405 for resourcesForChannelMeasurement); a zero-power interference measurement resource (ZP-IMR) (field 415 for csi-IM-ResourcesForInterference); and a non-zero-power interference measurement resource (NZP-IMR) (field 425 for nzp-CSI-RS-ResourcesForInterference). The CMR 405 is always configured in the CSI-ReportConfig 400 and has a field 410 for a first CSI-ResourceConfigID associated therewith. The ZP-IMR 415 is optionally configured and has a field 420 for a second CSI-ResourceConfigID associated therewith. The NZP-IMR 425 is optionally configured and has a field 430 for a third CSI-ResourceConfigID associated therewith.

The CSI-ResourceConfigID is associated with and used to identify a CSI resource configuration (CSI-ResourceConfig). The CSI-ResourceConfig IE defines a group of one or more CMR resources, ZP-IMR resources, or NZP-IMR resources.

FIG. 4b shows a CSI-ResourceConfig IE 450 for defining a group of one or more resource sets for CSI measurements according to existing specification. The CSI-ResourceConfig IE 450 can configure: a CMR resource set (CSI-SSB-ResourceSet 455); a ZP-IMR resource set (CSI-IM-ResourceSet 460); or a NZP-IMR resource set 465 (NZP-CSI-RS-ResourceSet 465). The CSI-ResourceConfig IE 450 further includes a field 470 for a BWP ID on which to perform the CSI measurements and a field 475 for the time domain behavior of the resource configuration (resourceType), e.g., aperiodic, semi-persistent or periodic.

The CSI-SSB-ResourceSet IE is used to configure one SS/PBCH block resource set. The CSI-SSB-ResourceSet IE defines a set of CSI/SSB resources and indicates the physical cell IDs (PCI) of the SSBs in the set.

FIG. 4c shows a CSI-SSB-ResourceSet IE 480 for configuring a resource set for CSI measurements according to existing specification. The CSI-SSB-ResourceSet IE 480 can configure a list of resources (CSI-SSB-ResourceList 485) and indicate a list of PCIs of the SSBs in the list (servingAdditionalPCIList 490).

A CSI report can include measurement quantities such as reference signal receive power (RSRP), reference signal received quality (RSRQ), and signal-to-noise and interference ratio (SINR). RSRP can be reported in units of decibels milliwatt (dBm), expressing an absolute power level, while RSRQ and SINR can be reported in units of dB.

For mobility purposes, a UE may measure RS transmitted from both the serving cell and one or more non-serving cells (neighbor cells). The UE can report these measurements to the network and, in some scenarios, the network can initiate mobility-related or load-related procedures, e.g., a handover of the UE from the serving cell to a neighbor cell.

Referring to the issues discussed above with regard to L1 measurements for LTM procedures, the first issue relates to a need to reduce latency in reporting CSI measurement results to timely trigger handover (HO) operations. In various aspects described herein, the UE can be configured to initiate CSI reporting for LTM based on the detection of a triggering event.

In one aspect, the event detection can be based on beam measurement results, e.g., reference signal received power (RSRP) or signal-to-noise ratio (SINR), for a serving cell and one or more non-serving cells. In some embodiments, the UE-initiated CSI reporting can be triggered when the UE detects the measurement results of a non-serving cell are some offset value better than (e.g., greater than) the measurement results of the serving cell. In other embodiments, the UE-initiated CSI reporting can be triggered when the UE detects the measurement results of the serving cell are worse than (e.g., less than) some first threshold value (e.g., T₁) and/or the measurement results of a non-serving cell are better than (e.g., greater than) some second threshold value (e.g., T₂).

The network can configure the UE, via radio resource control (RRC) signaling, with one or more parameters for the offset value, the first threshold value and/or the second threshold value. These value(s) can be configured via a new IE, referred to herein as EventTriggerConfig. Those skilled in the art will ascertain that this new IE can be referred to by a different name, e.g., in 3GPP specification. The network can further configure the UE with a type of measurement result, e.g., RSRP or SINR, to be measured against these values. The type of measurement can be configured with a reportQuantity IE associated with the offset and/or threshold value(s).

In one option, only the offset value is configured. In this option, when the UE detects the measurement results of a non-serving cell are some offset value better than (e.g., greater than) the measurement results of the serving cell, the UE can trigger the L1 measurement report. In another option, only the two threshold values (e.g., T₁ and T₂) are configured. In this option, when the UE detects the measurement results of the serving cell are worse than (e.g., less than) the first threshold value T₁ and the measurement results of a non-serving cell are better than (e.g., greater than) the second threshold value T₂, the UE can trigger the L1 measurement report. In still another option, both the offset value and the two threshold values are configured, and when the UE detects either the trigger condition defined by the offset value or trigger condition defined by the threshold values, the UE can trigger the L1 measurement report.

Various options may be considered for providing the offset value and/or the threshold values to the UE. In one embodiment, these parameters can be configured per CSI report and used for each beam associated with the CSI report. Referring to FIG. 4a above, the new IE EventTriggerConfig can be introduced to the CSI-ReportConfig IE. Correspondingly, these values are used by all CSI-SSB-ResourceSet associated with the CSI-ReportConfig.

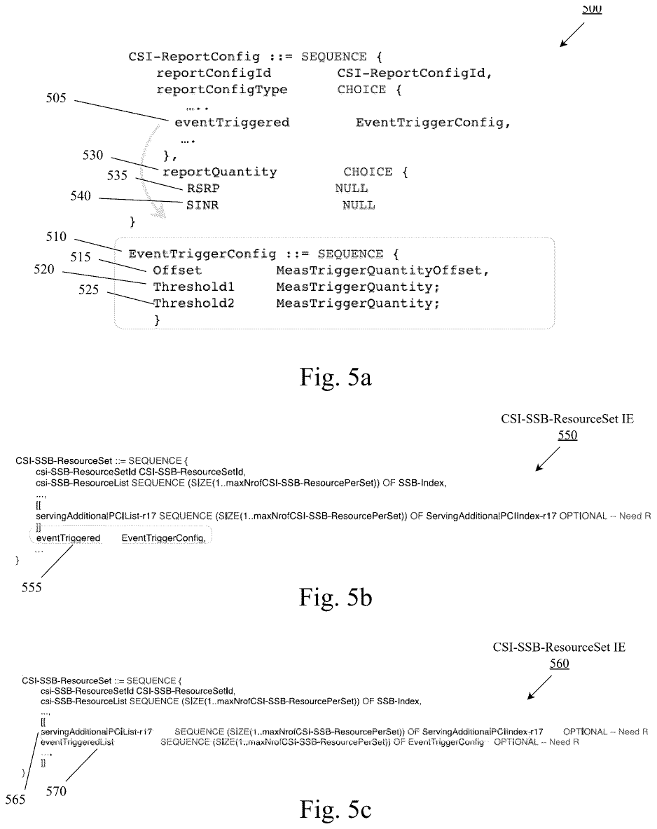

FIG. 5a shows a portion of a CSI-ReportConfig IE 500 for configuring a CSI report including one or more parameters for detecting a UE-initiated CSI reporting trigger event according to various exemplary embodiments. The CSI-ReportConfig 500 can include a field 505 for the trigger event associated with an EventTriggerConfig 510. As described above, the EventTriggerConfig 510 can include parameters for an offset 515, a first threshold 520 and/or a second threshold 525. The network can configure the offset 515, the first and second thresholds 520, 525, or all three values. In addition, a reportQuantity IE 530 may be provided in CSI-ReportConfig 500 by selecting one from two candidates RSRP 535 or SINR 540 that can be associated with SSB or CSI-RS measurement values, e.g., in dBm or dB.

In other embodiments, these parameters can be configured per resource set. Referring to FIG. 4c above, the new IE EventTriggerConfig can be introduced to the CSI-SSB-ResourceSet IE. In a first option, these parameters can be provided on a per SSB resource set basis for the corresponding non-serving cell. In this option, all SSB resources in a single SSB Resource Set can share a same configuration of these parameters, even they are associated with different non-serving cells.

FIG. 5b shows a CSI-SSB-ResourceSet IE 550 for configuring a resource set for CSI measurements including, on a per resource set basis, one or more parameters for detecting a UE-initiated CSI reporting trigger event according to various exemplary embodiments. The CSI-SSB-ResourceSet IE 550 can include a field 555 for the trigger event associated with an EventTriggerConfig, which can be the same EventTriggerConfig IE 510 described above in FIG. 5a including parameters for an offset 515, a first threshold 520 and/or a second threshold 525. The network can configure the offset 515, the first and second thresholds 520, 525, or all three values. The reportQuantity IE 530 can be provided in the CSI-ReportConfig 500 and be applied for the EventTriggerConfig IE 510 referred to in the field 555 of the CSI-SSB-ResourceSet IE 550.

In a second option, these parameters can be provided for each non-serving cell associated with an additionalPCIIndex value in the resource set configuration. The difference between these options is that the second option allows individual neighbor cells to appear either more or less attractive for LTM handover, e.g., for offloading purpose.

FIG. 5c shows a CSI-SSB-ResourceSet IE 560 for configuring a resource set for CSI measurements including, on a per non-serving cell basis, one or more parameters for detecting a UE-initiated CSI reporting trigger event according to various exemplary embodiments. The CSI-SSB-ResourceSet IE 560 includes a list of PCIs of the SSBs in the list (servingAdditionalPCIList 565) and, for each PCI, can include a field 570 for the trigger event associated with an EventTriggerConfig, which can be the Same EventTriggerConfig IE 510 described above in FIG. 5a including parameters for an offset 515, a first threshold 520 and/or a second threshold 525. The network can configure the offset 515, the first and second thresholds 520, 525, or all three values per PCI. The reportQuantity IE 530 can be provided in the CSI-ReportConfig 500 and be applied for the EventTriggerConfig IE 510 referred to in the field 570 of the CSI-SSB-ResourceSet IE 550 (per PCI).

Referring to the issues discussed above with regard to L1 measurements for LTM procedures, the second issue relates to how to report the L1 measured results associated with different neighbor cells to serve the mobility use case in an efficient manner.

According to further aspects of the present disclosure, a variety of approaches may be considered for allocating resources for the UE-initiated CSI report associated with LTM events. In some embodiments, the CSI report is transmitted on semi-persistent (SP) PUCCH resources. In other embodiments, the CSI report is transmitted on PUSCH resources. In various embodiments, the PUSCH resources can be requested via scheduling request (SR) or random access channel (RACH) procedures.

In one option, the UE-initiated CSI report is transmitted on SP PUCCH resources. The SP PUCCH resources can be configured by RRC signaling as part of CSI-ReportConfig. When the UE-initiated CSI report is activated (triggered) based on the event definition provided by the event trigger parameters, the corresponding PUCCH resource can be activated for CSI report.

In another option, the PUSCH resources can be requested by a scheduling request (SR). A dedicated SR resource can be provided to the UE as part of CSI-ReportConfig (in addition to the event definition parameters). This SR resource (over PUCCH) can be used to request PUSCH resource from the network to convey the UE-initiated CSI report. This SR resource can be used only when UL-SCH resources are not available to transmit the triggered CSI report. If UL-SCH resources are available, then the SR request is not necessary. The SR resource configuration can include parameters such as, e.g., SR-ID, SR-prohibitTimer, SR-TransMax, etc.

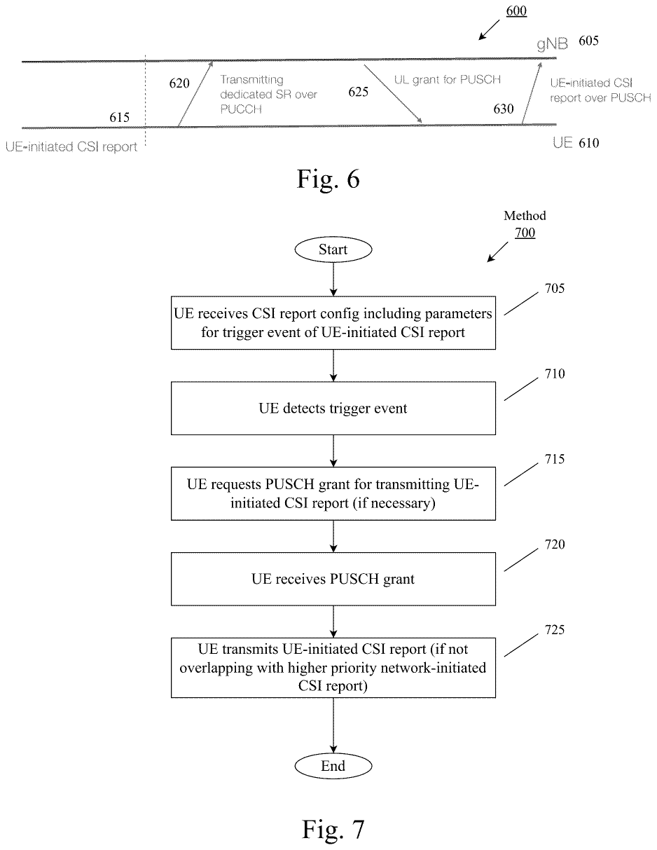

FIG. 6 shows an exemplary signaling diagram 600 for a UE-initiated CSI report using a UL grant provided in response to a scheduling request (SR) according to various exemplary embodiments. The signaling diagram 600 includes a UE 605 and a gNB 610.

In 615, the gNB 605 configures the UE 610 for the UE-initiated CSI report. The configuration (CSI-ReportConfig) includes a dedicated SR resource for requesting a UL grant to transmit the CSI report. The CSI-ReportConfig can include SR configuration parameters.

In 620, the UE 610 detects the occurrence of the triggering event and transmits the dedicated SR over PUCCH. In 625, the UE 610 receives the UL grant for PUSCH. In 630, the UE 610 transmits the CSI report over PUSCH.

In still another option, a RACH procedure can be used to request PUSCH resource for UE-initiated CSI report transmission. The UE may be provided a dedicated PRACH resource to be used for UE-initiated CSI reporting. If the UE is not configured with a dedicated contention-free RA (CFRA) RACH resource, a contention-based RA (CBRA) procedure can be used for PUSCH resource request.

According to further aspects of the present disclosure, various options may be considered for handling the case of collision (overlapping) between the UE-initiated CSI report and a network-initiated CSI report when these two types of CSI report are associated with a same CSI-SSB-ResourceSet. Either one of the two types of CSI report can be prioritized based on a hard-encoded rule, network indication (e.g., system information block (SIB) or dedicated RRC), or UE implementation.

In one option, a rule can be hard encoded in a specification (e.g., 3GPP standards) to prioritize one of the two types of CSI report. In one embodiment, the network-initiated CSI report is prioritized to minimize the latency of the report transmission.

In another option, an indicator may be introduced for indicating the prioritization order for the two report types. In one embodiment, the indicator can be provided by a system information block (SIB). In another embodiment, the indicator can be provided by dedicated RRC signaling e.g., CSI-ReportConfig. The indicator can comprise a single bit, wherein the value of ‘0’ indicates network-triggered CSI reporting is prioritized and the value of ‘1’ indicates UE-triggered CSI reporting is prioritized.

In still another option, it may be left to UE implementation to pick one CSI report to transmit from these overlapping CSI reports.

FIG. 7 shows a method 700 for UE-initiated CSI reporting based on the detection of a trigger event according to various exemplary embodiments.

In 705, the UE receives a CSI report configuration (CSI-ReportConfig) including parameters for detecting a triggering event for a UE-initiated CSI report. The event detection parameters can be included in a new IE, e.g., EventTriggerConfig, that is configured per CSI report, per resource set, or per cell (serving and/or neighbor). The event detection parameters can include an offset value (measured between the serving cell and the neighbor cells) and/or a first threshold value (measured against the serving cell) and a second value (measured against the neighbor cells). The reportQuantity IE can indicate the type of measurement value, e.g., RSRP or SINR, for the UE to measure.

In some embodiments, the UE further receives SP PUCCH resources in the CSI-ReportConfig for transmitting the UE-initiated CSI report. In other embodiments, the UE receives a dedicated SR resource for requesting PUSCH resources to transmit the UE-initiated CSI report. In still other embodiments, the UE receives a dedicated PRACH resource for requesting PUSCH resources to transmit the UE-initiated CSI report.

In 710, the UE detects the triggering event. For example, measurement values for the serving may be the offset value worse than measurement values for a non-serving cell, or measurement values for the serving may be worse than the first threshold value while measurement values for a non-serving cell are better than the second threshold value.

In 715, if a resource for transmitting the UE-initiated CSI report is not available (e.g., the UE was not configured with a SP PUCCH resource for transmitting the UE-initiated CSI report, and/or PUSCH resources are not available), the UE requests a PUSCH grant for transmitting the UE-initiated CSI report. In one option, the UE transmits a SR requesting the PUSCH grant. In another option, the UE transmits a PRACH on a dedicated PRACH resource requesting the PUSCH grant. In still another option, the UE transmits a PRACH in a contention-based RA procedure requesting the PUSCH grant.

In 720, the UE receives a PUSCH grant for transmitting the UE-initiated CSI report.

In 725, the UE transmits the UE-initiated CSI report if the UE-initiated CSI report does not have a lower priority than a network-initiated CSI report overlapping with the UE-initiated CSI report. For example, the UE may have a rule hard encoded in specification to prioritize one of the two types of CSI report. In another example, the network can indicate via SIB or dedicated RRC signaling which of the two types of CSI report should be prioritized. In still another example, the prioritization is left to UE implementation.

Referring to the issues discussed above with regard to L1 measurements for LTM procedures, the third issue relates to the design of the CSI report, e.g., fixed size or variable size, when the CSI report is to be transmitted on the PUSCH.

In further aspects of these exemplary embodiments, the CSI report for non-serving cell beam reporting of L1/L2 Triggered Mobility (LTM) can be constructed in various ways. In some embodiments, when the CSI report is transmitted on the PUSCH, the CSI report can be transmitted via an uplink (UL) medium access control (MAC) control element (MAC-CE). The MAC-CE can have a fixed size or a variable size. The network can configure the UE with a number of beams to report on a per-CSI report or per-cell basis. Additionally, in some embodiments, the network can configure the UE with a threshold measurement value so that the beam measurements can be filtered prior to reporting so that only those beams whose measured results are above the threshold measurement value are included in the CSI report.

In one aspect, new parameters may be introduced for UE capabilities with different definitions and usages. In one embodiment, a new parameter ‘K’ can be introduced for UE capability reporting that represents the ‘maximal number of configured Tx beams’ for beam measurement across the serving cell and non-serving cells on a same frequency layer. In another embodiment, a second parameter ‘N_max’ can be introduced that represents the ‘maximal number of configured Tx beams to be reported’ in one CSI reporting instance.

Based on the ‘K’ and “N_max” parameters received in UE capability report, the network can configure the UE with a number of beams for beam measurement across serving/non-serving cells that is ≤K and can additionally configure the UE with a value ‘N’ that is ≤N_max, wherein N represents the number (N) of measured RS resources to be reported per report setting. The N value can be configured in the nrofReported RS IE in CSI-ReportConfig.

The value N can indicate a total number of RS or a number of RS per non-serving cell for which to include L1 measurement results for a given report instance. In a first option, the UE includes ‘N’ RS indices, e.g., SSB indexes or CSI-RS indexes provided by a CSI-SSB-ResourceSet IE in order of decreasing sorting quantity (e.g., starting with the best measurement results and continuing to the second best results, . . . , Nth best results) across ‘all’ non-serving cells associated with the CSI-SSB-ResourceSet. In a second option, the UE includes ‘N’ RS indices in order of decreasing sorting quantity for ‘each’ non-serving cells associated with the given CSI-SSB-ResourceSet. For the second option, the total reported RS index is ‘N*M’, where ‘M’ represents the number of non-serving cells for which the UE is configured to measure RS.

In the first option, the UE reports measurement values only for beams from the ‘best’ neighbor cells. In the second option, the UE reports measurement values for beams from all neighbor cells. Use of the second option may be motivated by the ‘offloading’ use case, e.g., where certain cells are in high load or low load scenarios and the network determines to increase/decrease the loading of the cell. It may be useful for the network to select amongst the first and second options. In a third option, the network can select from among the first and second options based on the use case e.g., cell size, high/med/low load case at network, etc., and configure the UE to use one of the two options. A new IE may be introduced for this purpose, e.g., to be included in CSI-ReportConfig.

In another aspect of these exemplary embodiments, the UE can include L1 measurement results only for beams with measurement results meeting a threshold value. This threshold can be used commonly for both options discussed above, wherein the value N indicates a total number of RS or a number of RS per neighbor cell. In these embodiments, these N RS can be filtered further so that only measurement results whose sorting quantity is above the threshold value are included in the CSI report.

The threshold parameter may be referred to as ‘absThresh’ and can be configured in the CSI-SSB-ResourceSet IE. When ‘absThresh’ is included, the threshold value can be applied for the associated CSI report so that the measured results whose sorting quantity is above ‘absThresh’ value are included. In these aspects, the CSI-report overhead can be minimized by including only ‘qualified’ results. However, the network is provided with less information upon to which to base any mobility-related decisions.

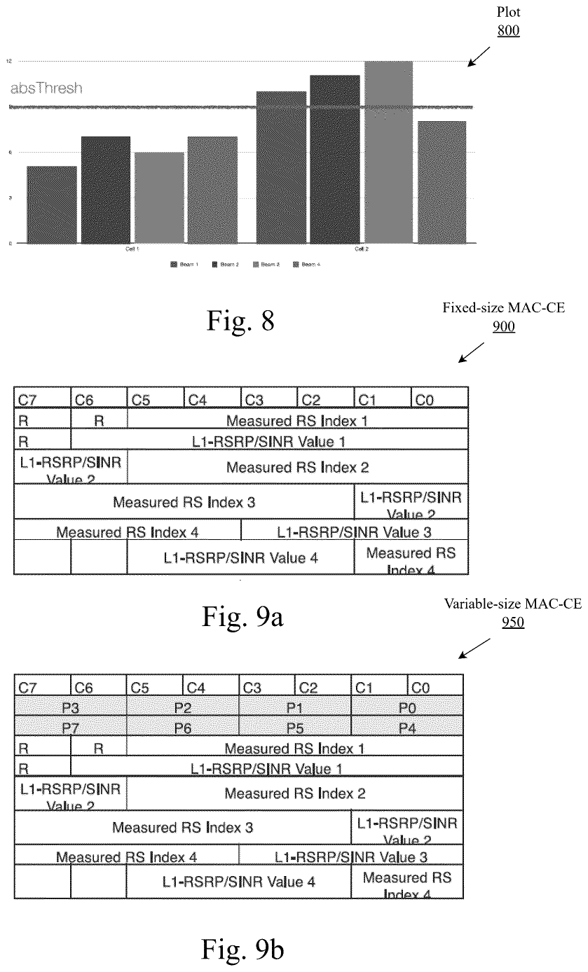

FIG. 8 shows an exemplary plot 800 of measurement results for a first cell and a second cell with respect to an exemplary threshold value according to various exemplary embodiments. The plot 800 shows one example of measurement result filtering based on an RRC-configured threshold (absThresh) value of 9 dB. In this example, it is assumed that the first and second cells (e.g., Cell 1 and Cell 2) were configured by a CSI-SSB-ResourceSet IE for L1 CSI reporting including reporting of four SSBs (SSB 1, SSB2, SSB3 and SSB4) per cell.

For a given CSI report instance, the measured L1-RSRP is assumed as shown in FIG. 8. The absThresh value is shown as a solid line. For Cell 1, the measurement values for SSB 1, SSB 2, SSB 3 and SSB 4 are all below the absThresh value. The measurement values, in descending order, proceed as: SSB 4 (highest), SSB 2, SSB 3 and SSB 1 (lowest). For Cell 2, the measurement values for SSB 1, SSB 2 and SSB 3 are above the absThresh value and the measurement value for SSB 4 is below the absThresh value. The measurement values, in descending order, proceed as: SSB 3 (highest), SSB 2, SSB 1 and SSB 4 (lowest). Additionally, the measurement values for all SSBs of Cell 2 are greater than the measurement values for all SSBs of Cell 1.

In the following, exemplary L1 measurement reporting operations are described for the various options discussed above. In this example, the value ‘N’ of nrofReportedRS is assumed to be 4 when the first option is used (wherein N applies to a total number of RS across all cells) and the value ‘N’ of nrofReportedRS is assumed to be 2 when the second option is used (wherein N applies to RS for each cell).

In a first scenario, the ‘N’ value is indicated for ‘all’ cells, e.g., measurement values for ‘N’ total RS across the serving cell and all configured neighbor cells can be included in the measurement report according to the first option (where N=4), and the absThresh parameter is not configured. In this scenario, measurement results for the 4 best RS are reported in decreasing sorting quantity. Thus, because all four SSB of Cell 2 have measurement values greater than those of the SSB of Cell 1, no measurement values are reported for the SSB of Cell 1 and the four measurement values corresponding to the four SSB of Cell 2 are reported (for a total of 4). The order of the measurement results proceeds as SSB 3 (highest), SSB 2, SSB 1 and SSB 4 (lowest), all for Cell 2.

In a second scenario, the ‘N’ value is indicated for ‘each’ cell, e.g., measurement values for ‘N’ RS for the serving cell and each configured neighbor cell can be included in the measurement report according to the second option (where N=2), and the absThresh parameter is not configured. In this scenario, measurement results for the 2 best RS for each cell are reported in decreasing sorting quantity. Thus, measurement values are reported for 2 SSB of Cell 1 and 2 SSB of Cell 2. four SSB of Cell 2 have measurement values greater than those of the SSB of Cell 1, no measurement values are reported for the SSB of Cell 1 and the four measurement values corresponding to the four SSB of Cell 2 are reported (for a total of 4). The order of the measurement results proceeds as Cell 2 SSB 3 (highest), Cell 2 SSB 2, Cell 1 SSB 4, Cell 1 SSB 2 (lowest).

In a third scenario, the ‘N’ value is indicated for ‘all’ cells, e.g., measurement values for ‘N’ total RS across the serving cell and all configured neighbor cells can be included in the measurement report according to the first option (where N=4), and the absThresh parameter is configured as 9, as shown in FIG. 7. In this scenario, measurement results for the RS whose measurement values exceed 9 dB are reported in decreasing sorting quantity up to a maximum of 4(N=4). Thus, because three SSB of Cell 2 have measurement values greater than 9 dB and no SSB of Cell 1 have measurement values greater than 9 dB, no measurement values are reported for the SSB of Cell 1 and the three measurement values corresponding to SSB 1, 2 and 3 of Cell 2 are reported (for a total of 3). The order of the measurement results proceeds as SSB 3 (highest), SSB 2, SSB 1 (lowest), all for Cell 2.

In a fourth scenario, the ‘N’ value is indicated for ‘each’ cell, e.g., measurement values for ‘N’ RS for the serving cell and each configured neighbor cell can be included in the measurement report according to the second option (where N=2), and the absThresh parameter is configured as 9, as shown in FIG. 7. In this scenario, measurement results for the RS whose measurement values exceed 9 dB are reported in decreasing sorting quantity up to a maximum of 2(N=2) per cell. Thus, because three SSB of Cell 2 have measurement values greater than 9 dB and no SSB of Cell 1 have measurement values greater than 9 dB, no measurement values are reported for the SSB of Cell 1 and the two best measurement values corresponding to SSB 2 and 3 of Cell 2 are reported (for a total of 2). The order of the measurement results proceeds as SSB 3 (highest) and SSB 2 (lowest), both for Cell 2.

As demonstrated above, depending on the configuration parameters for CSI reporting, specifically, whether or not the threshold parameter absThresh is configured, the CSI report may comprise a fixed size or a variable size. If the threshold is not used, the UE will always report measurement results for N beams (total or for each cell, depending on which option is used for ‘N’), e.g., a fixed quantity. If the threshold is used, the UE may report measurement results for any number of beams less than or equal to a maximum of N, depending on whether the measurement values for these beams, e.g., a variable quantity.

According to further aspects of these exemplary embodiments, a new MAC-CE can be introduced for LI CSI reporting for LTM procedures. The MAC-CE is identified by a MAC sub-header with a dedicated extended logical channel ID (eLCID). In some embodiments, the new MAC-CE can have a fixed size. In other embodiments, the new MAC-CE can have a variable size.

FIG. 9a shows a fixed size MAC-CE 900 for LI CSI reporting for LTM procedures according to various exemplary embodiments. In this example, the network configures a number N of RS to report and does not configure a threshold for measurement results to include. The total number of number of reported RS Indices for cell i, if reported, is configured by RRC signaling or hard encoded in specification. Thus, the network knows the size of the CSI report it expects to receive, and this size does not need to be indicated by the UE in the MAC-CE 800.

The MAC-CE 900 includes an octet for a Cᵢ field for indicating the presence of L1 measurement results for the serving cell and/or non-serving cells, wherein i=0 for the serving cell or SpCell and, for non-serving cells, i is the value of the associated ‘additionalPCIIndex’ value configured in CSI-SSB-ResourceSet. The Cᵢ field can indicate a 0 if measurement results are not included for the cell and can indicate a 1 if measurement results are included for the cell.

The MAC-CE 900 additionally includes a number of Measured RS Index i fields, each with an associated L1-RSRP/SINR Value i field. The measured resource RS (e.g., SSB or CSI-RS) index corresponds to the entry index in the CSI resource list and the corresponding measured result. In some embodiments, the index i=1 can correspond to the RS index having a largest measured RSRP/SINR value and comprise a 7-bit value with 1 dB step size. In these embodiments, the indices i>1 can correspond to RS indices having other measured RSRP/SINR values and comprise a 4 bit value. The indices i>1 can be reported as differential values with 2 dB step size with reference to the largest measured value with index i=1.

FIG. 9b shows a variable size MAC-CE 950 for L1 CSI reporting for LTM procedures according to various exemplary embodiments. In this example, the network configures a number N of RS to report and further configures a threshold for measurement results to include. Thus, the network does not know the size of the CSI report it expects to receive, and this size can be indicated by the UE in the MAC-CE 950.

The MAC-CE 950 includes the octet for the Cᵢ field and the number of Measured RS Index i fields, each with an associated L1-RSRP/SINR Value i field, as described above for the fixed size MAC-CE 900. The MAC-CE 950 additionally includes two octets for a number of 2-bit Pᵢ fields. The Pᵢ field comprises 2-bits for indicating a number of RS up to 4, assuming the value N for ‘nrofReportedRS’ can be set up to 4 per cell. Those skilled in the art will ascertain that the size of the Pᵢ field can be increased if the value N can be greater than 4.

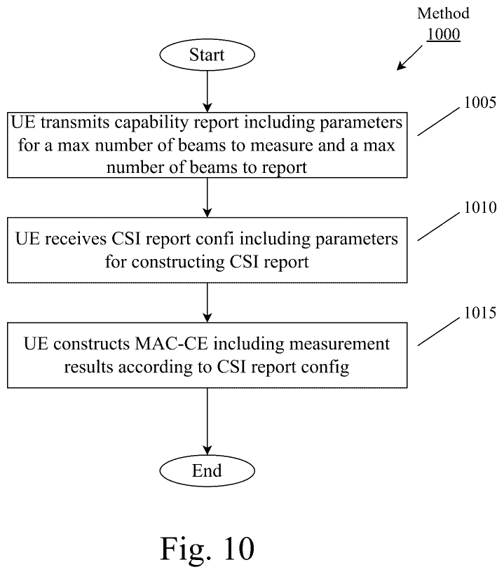

FIG. 10 shows a method 1000 for constructing a CSI report for non-serving cell beam reporting for L1/L2 Triggered Mobility (LTM) according to various exemplary embodiments.

In 1005, the UE transmits a capability report to the network. The capability report can include a parameter ‘K’ representing a maximal number of beams that can be configured for CSI measurements. The capability report can further include a parameter “N_max” representing a maximal number of Tx beams that can be reported.

In 1010, the UE receives a CSI report configuration (CSI-ReportConfig) including parameters for constructing the CSI report for non-serving cell beam reporting for LTM. The parameters can include a number of beams for beam measurement across serving/non-serving cells that is ≤K and a value ‘N’ that is ≤N_max, wherein N represents the number (N) of measured RS resources to be reported per report setting. The N value can, in some embodiments, indicate a total number of RS to report. In other embodiments, the N value can indicate a number of RS to report per non-serving cell. In some embodiments, the network can indicate which of the two options the ‘N’ value refers to.

In some embodiments, the N value can correspond to a maximum number of RS to report and the configuration parameters can further include a threshold value (absThresh). When the threshold value is configured, only measurement values greater than the threshold value are included in the CSI report.

In 1015, the UE constructs a MAC-CE including measurement results for a number of RS according to the CSI report configuration. For example, the MAC-CE can include indices for the number N of measured RS with associated measurement results (fixed size MAC-CE) or can include indices for a number of measured RS with associated measurement results greater than the configured threshold (variable size MAC-CE). If the MAC-CE is a variable size MAC-CE, the MAC-CE includes fields for indicating a number of measurement results included per cell.

### EXAMPLES

In a first example, a processor of a base station is configured to transmit to a user equipment (UE) a channel state information (CSI) report configuration that includes parameters to detect a triggering event for a UE-initiated CSI report, the triggering event being based on measurement results derived based on reference signals (RS) received from a serving cell and measurement results derived based on RS received from at least one non-serving cell and if the UE-initiated CSI report does not have a lower priority than a network-initiated CSI report that overlaps with the UE-initiated CSI report, receive the UE-initiated CSI report after the UE detects the triggering event based on at least the measurement results derived based on the RS received from the serving cell and the at least one non-serving cell.

In a second example, the processor of the first example, wherein the parameters to detect the triggering event include an offset value and the triggering event is detected when the measurement values derived based on the RS received from the serving cell are less than the measurement values derived based on the RS from the non-serving cell by a value greater than the offset value.

In a third example, the processor of the first example, wherein the parameters to detect the triggering event include a first threshold value and a second threshold value and the triggering event is detected when the measurement values derived based on the RS received from the serving cell are less than the first threshold value and the measurement values derived based on the RS from the non-serving cell are greater than the second threshold value.

In a fourth example, the processor of the first example, wherein the parameters to detect the triggering event are included in CSI-ReportConfig and are used for all CSI-SSB-ResourceSet associated with the CSI-ReportConfig.

In a fifth example, the processor of the first example, wherein the parameters to detect the triggering event are included in CSI-SSB-ResourceSet on a per resource set basis.

In a sixth example, the processor of the first example, wherein the parameters to detect the triggering event are included in CSI-SSB-ResourceSet on a per non-serving cell basis.

In a seventh example, the processor of the first example, further configured to transmit a semi-persistent (SP) physical uplink control channel (PUCCH) resource configuration for transmission of the UE-initiated CSI report, wherein the UE-initiated CSI report is received on the SP PUCCH resource when the triggering event is detected by the UE.

In an eighth example, the processor of the first example, further configured to transmit a dedicated scheduling request (SR) resource configuration to request a physical uplink shared channel (PUSCH) resource to transmit the UE-initiated CSI report, receive the dedicated SR when the triggering event is detected by the UE and transmit a grant for the PUSCH resource, wherein the UE-initiated CSI report is received on the PUSCH resource when the triggering event is detected by the UE.

In a ninth example, the processor of the first example, further configured to transmit a dedicated physical random access channel (PRACH) resource configuration to request a physical uplink shared channel (PUSCH) resource to transmit the UE-initiated CSI report, receive a PRACH on the dedicated PRACH resource when the triggering event is detected by the UE and transmit a grant in a Random Access Response (RAR) for the PUSCH resource, wherein the UE-initiated CSI report is received on the PUSCH resource when the triggering event is detected by the UE.

In a tenth example, the processor of the first example, further configured to receive a physical random access channel (PRACH) in a contention-based random access procedure when the triggering event is detected by the UE and transmit a grant for the PUSCH resource, wherein the UE-initiated CSI report is received on the PUSCH resource when the triggering event is detected by the UE.

In an eleventh second example, the processor of the first example, further configured to transmit an indication for the UE to prioritize either the UE-initiated CSI report or the network-initiated CSI report when the network-initiated CSI report overlaps with the UE-initiated CSI report in time.

In a twelfth, the processor of the eleventh example, wherein the indication is provided in a system information block (SIB) or dedicated radio resource control (RRC) signaling.

In a thirteenth example, a processor of a user equipment (UE) is configured to receive a channel state information (CSI) report configuration that includes parameters to construct a CSI report, wherein the parameters include one or more RS for a serving cell and one or more RS for a non-serving cell, the parameters further include a value that indicates a number of RS to report or a maximum number of RS to report per report setting, construct a medium access control (MAC) control element (MAC-CE) that includes a field that indicates a presence of measurement results for the serving cell or one of the non-serving cells, the MAC-CE further includes indices and the measurement results for the one or more RS for the serving cell or the one or more RS for the one of the non-serving cells, wherein the measurement results are provided in order of decreasing measurement quantities, and transmit the MAC-CE that includes the measurement results for the number of RS or a number of RS less than the maximum number of RS with associated measurement values as the CSI report.

In a fourteenth example, the processor of the thirteenth example, wherein the MAC-CE comprises a fixed size MAC-CE that includes a number of fields for the indices of the RSs and the measurement results based on the value that indicates the number of RS to report.

In a fifteenth example, the processor of the fourteenth example, wherein a first field for first measurement results comprises a number of bits greater than further fields for further measurement results.

In a sixteenth example, the processor of the fifteenth example, wherein the first field for the first measurement results directly indicates a first measurement value and the further fields for further measurement results indicate measurement values relative to the first measurement value.

In a seventeenth example, the processor of the sixteenth example, wherein the first field comprises 7 bits with a 1 decibel step size and the further fields comprise 4 bits with a 2 decibel step size.

In an eighteenth example, the processor of the thirteenth example, wherein the parameters to construct the CSI report further include a threshold value that indicates a minimum measurement value, wherein only measurement values greater than the threshold value are included in the CSI report.

In a nineteenth example, the processor of the eighteenth example, wherein the MAC-CE comprises a variable size MAC-CE including fields that indicates a number of reported RS indices per cell.

In a twentieth example, the processor of the nineteenth example, wherein the fields that indicate the number of reported RS indices per cell comprises 2 bits, wherein a codepoint value of ‘00’, ‘01’, ‘10’, ‘11’ of the 2-bit field are one-to-one mapped to indicate 1 or 2 or 3 or 4 RSs, respectively, of the cell included in the MAC-CE.

In a twenty first example, the processor of the thirteenth example, further configured to report a UE capability for a maximal number of beams that can be configured for CSI measurements of non-serving cells.

In a twenty second example, the processor of the thirteenth example, further configured to report a UE capability for a maximal number of beams that can be reported for CSI measurements of non-serving cells.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to:
receive a channel state information (CSI) report configuration that includes parameters to detect a triggering event for a UE-initiated CSI report, the triggering event being based on measurement results derived based on reference signals (RS) received from a serving cell and measurement results derived based on RS received from at least one non-serving cell;
detect the triggering event based on at least the measurement results derived based on the RS received from the serving cell and the at least one non-serving cell; and
if the UE-initiated CSI report does not have a lower priority than a network-initiated CSI report that overlaps with the UE-initiated CSI report, transmit the UE-initiated CSI report that includes the measurement results derived based on the RS received from the serving cell and the at least one non-serving cell.

2. The processor of claim 1, wherein the parameters to detect the triggering event include an offset value and the triggering event is detected when the measurement values derived based on the RS received from the serving cell are less than the measurement values derived based on the RS from the non-serving cell by a value greater than the offset value.

3. The processor of claim 1, wherein the parameters to detect the triggering event include a first threshold value and a second threshold value and the triggering event is detected when the measurement values derived based on the RS received from the serving cell are less than the first threshold value and the measurement values derived based on the RS from the non-serving cell are greater than the second threshold value.

4. The processor of claim 1, wherein the parameters to detect the triggering event are included in CSI-ReportConfig and are used for all CSI-SSB-ResourceSet associated with the CSI-ReportConfig.

5. The processor of claim 1, wherein the parameters to detect the triggering event are included in CSI-SSB-ResourceSet on a per resource set basis.

6. The processor of claim 1, wherein the parameters to detect the triggering event are included in CSI-SSB-ResourceSet on a per non-serving cell basis.

7. The processor of claim 1, further configured to:
receive a semi-persistent (SP) physical uplink control channel (PUCCH) resource configuration for transmission of the UE-initiated CSI report,
wherein the UE-initiated CSI report is transmitted on the SP PUCCH resource when the triggering event is detected.

8. The processor of claim 1, further configured to:
receive a dedicated scheduling request (SR) resource configuration to request a physical uplink shared channel (PUSCH) resource to transmit the UE-initiated CSI report;
transmit the dedicated SR when the triggering event is detected; and
receive a grant for the PUSCH resource,
wherein the UE-initiated CSI report is transmitted on the PUSCH resource when the triggering event is detected.

9. The processor of claim 1, further configured to:
receive a dedicated physical random access channel (PRACH) resource configuration to request a physical uplink shared channel (PUSCH) resource to transmit the UE-initiated CSI report;
transmit a PRACH on the dedicated PRACH resource when the triggering event is detected; and
receive a grant in a Random Access Response (RAR) for the PUSCH resource,
wherein the UE-initiated CSI report is transmitted on the PUSCH resource when the triggering event is detected.

10. The processor of claim 1, further configured to:
transmit a physical random access channel (PRACH) in a contention-based random access procedure when the triggering event is detected; and
receive a grant for the PUSCH resource,
wherein the UE-initiated CSI report is transmitted on the PUSCH resource when the triggering event is detected.

11. The processor of claim 1, wherein the UE comprises a rule hard-encoded in specification to prioritize either the UE-initiated CSI report or the network-initiated CSI report when the network-initiated CSI report overlaps with the UE-initiated CSI report in time.

12. The processor of claim 1, further configured to:
receive a network indication to prioritize either the UE-initiated CSI report or the network-initiated CSI report when the network-initiated CSI report overlaps with the UE-initiated CSI report in time.

13. The processor of claim 12, wherein the network indication is provided in a system information block (SIB) or dedicated radio resource control (RRC) signaling.

14. The processor of claim 1, wherein a predefined UE implementation selection is used to prioritize either the UE-initiated CSI report or the network-initiated CSI report when the network-initiated CSI report overlaps with the UE-initiated CSI report in time.

15. A processor of a user equipment (UE) configured to:
receive a channel state information (CSI) report configuration that includes parameters to construct a CSI report, wherein the parameters include one or more RS for a serving cell and one or more RS for a non-serving cell, the parameters further include a value that indicates a number of RS to report or a maximum number of RS to report per report setting;
construct a medium access control (MAC) control element (MAC-CE) that includes a field that indicates a presence of measurement results for the serving cell or one of the non-serving cells, the MAC-CE further includes indices and the measurement results for the one or more RS for the serving cell or the one or more RS for the one of the non-serving cells, wherein the measurement results are provided in order of decreasing measurement quantities; and
transmit the MAC-CE that includes the measurement results for the number of RS or a number of RS less than the maximum number of RS with associated measurement values as the CSI report.

16. The processor of claim 15, wherein value indicates the number of RS to report as a total number of measured RS that have highest measurement values across the serving cell and the one or more non-serving cells.

17. The processor of claim 15, wherein the value indicates the number of RS to report as a number of measured RS having highest measurement values per each cell that includes the serving cell and the one or more non-serving cells.

18. The processor of claim 15, further configured to:
receive an indication that the value indicates the number of RS to report as a total number of measured RS that have highest measurement values across the serving cell and the one or more non-serving cells or the value indicates the number of RS to report as a number of measured RS having highest measurement values per each cell that includes the serving cell and the one or more non-serving cells.

19. The processor of claim 15, wherein the MAC-CE comprises a fixed size MAC-CE that includes a number of fields for the indices of the RSs and the measurement results based on the value that indicates the number of RS to report.

20. The processor of claim 15, wherein the parameters to construct the CSI report further include a threshold value that indicates a minimum measurement value, wherein only measurement values greater than the threshold value are included in the CSI report.
